(19) United States
(12) Patent Application Publication
(10) Pub. No.: US 2007/0011101 A1
(43) Pub. Date: Jan. 11, 2007

(54) Work support system, work support method, computer-readable recording medium storing a work support program thereon, work support information creating system, work support information creating method, and computer-readable recording medium storing a work support information creating program thereon

(75) Inventors: Masayuki Kidera, Kawasaki (JP); Tsukasa Tenma, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/255,921

(22) Filed: Oct. 24, 2005

(30) Foreign Application Priority Data
Jul. 8, 2005 (JP) 2005-199544

(51) Int. Cl. H04K 1/00

(52) U.S. Cl. 705/71

(57) ABSTRACT

The work support system which shows a worker presentation information for supporting the worker at work, the system comprising: an information storing unit which stores therein the presentation information and work identification information identifying the work as associated work support information; a work identification information inputting unit through which the work identification information is input; an information obtaining unit which obtains the presentation information relating to the work identification information from the information storing unit, based on the work identification information; and a display control unit which controls the display unit to show thereon the presentation information obtained by the information obtaining unit. The present system makes it easy to create work support information, and improve user convenience by presenting only work support information appropriate for the current work.

### BACKGROUND OF THE INVENTION

(1) Field of the Invention

The present invention relates to an art for supporting a worker by presenting presentation information at work.

(2) Description of the Related Art

CAD (Computer Aided Design) has been normally used in development of products, and design data created by CAD is used in varying occasions.

For example, an art is known in which various comments (notes) are shown together with design data created by CAD so that the contents of work to be performed to a product is described by the comments for a worker. The following patent document 1 discloses a technique in which information about manufacturing processes, manufacturing instructions, inspection instructions, and assembly instructions are added to a model designed by a three-dimensional CAD. Such added information gives a worker instructions for work in order to support the worker at work.

Further, a technique is known in which the contents and the procedures of work are shown to a worker by animation (instruction animation) for supporting the work of the worker. This instruction animation is made by moving components and by moving/zooming in and out of views, and at processes at which any comment is to be shown, notes are displayed/non-displayed repeatedly. Such animation is used in a variety of scenes, for example, when instructions are given for assembly at manufacturing, when instructions are given for disassembly of reclaimed products, and when inspection is carried out for movement of equipment and movement of a person who operates equipment.

[Patent Document 1] Japanese Patent Application Laid-open No. 2004-240659

However, in such a previous work support method, at the time data for instruction is created, notes are repetitively added to the design data. As a result, notes for a variety of work scenes are present in the same design data, and more than one note is displayed in the work instruction data, so that which note is for which work scene is difficult to know.

FIG. 12 is a diagram which shows work instruction data made by the previous work support information creating method. FIG. 12 is to be referred to when a worker operates and inspects an ATM. FIG. 12 shows an ATM and a human model together with four notes (“Is the LCD clear?”, “Are key buttons usable by a person with big fingers?”, “Is it easy to receive cash?”, and “Is it easy to put a card into the slot?”) which are referred to when an inspection of equipment operation is performed, and three notes (“Dose not the cover close due to its own weight?”, “Is the safe unit taken out smoothly?”, and “Does not any other components interfere with the cover when the cover opens?”) which are referred to at an disassembly operation.

Normally, at the time of an inspection of disassembly, it is almost not necessary to refer to such notes, which relates to an inspection of equipment operation. However, as shown in FIG. 12, the work instruction data created and shown by the previous work support information creating method contains the notes relating to the inspection of equipment operation even at the time of disassembly operation. Thus, a worker needs to choose necessary information therefrom.

Further, as to the instruction animation which shows the procedures of work, for example, by replaying the same animation in the forward direction and in the backward direction, it is possible to show an assembly process and a disassembly process. Together with the animation, only note comments which are shown in the animation are changed, or newly independent note comments are defined. In such a manner, data (work instruction data) of two instruction animations, one for assembly, and the other for disassembly, are prepared.

In such a case, if the contents of note comments are changed in the already prepared work instruction data, the work instruction data is canceled. In addition, when newly defining independent note comments in the instruction animation, it is necessary to reset the timing with which the note comments are displayed (or non-displayed), so that complicated procedures are needed.

Further, when inserting notes in the animation, it sometimes occurs that the position of a note should not be changed but the contents of the note should be changed in other work scene. For example, when the note of “attach component C to component B” should be displayed in assembly processing, and the note of “detach component C from component B” should be displayed in disassembly processing, these comments are preferably shown in the same position in the animation screen image, and the display is selected in accordance with the work scenes.

However, in the previous work support technique, it is necessary for a creator of the instruction animation to specify the position of note comments once again or to write over the already written comments, so that the complicated procedures are necessitated.

### SUMMARY OF THE INVENTION

With the foregoing problems in view, it is an object of the present invention to make it easy to create work support information, and to display only work support information appropriate for work, thereby improving the user convenience.

In order to accomplish the above object, according to the present invention, there is provided a work support system which shows a worker presentation information for supporting the worker at work, the system comprising: a display unit which shows the presentation information thereon; an information storing unit which stores therein the presentation information and work identification information identifying the work as associated work support information; a work identification information inputting unit through which the work identification information relating to work whose presentation information is expected to be shown is input; a information obtaining unit which obtains the presentation information relating to the work identification information, input through the work identification information inputting unit, from the information storing unit; and a display control unit which controls the display unit to show thereon the presentation information obtained by the information obtaining unit.

As a preferred feature, the display control unit controls the display unit to show thereon the presentation information obtained by the information obtaining unit in a display form different from that of other presentation information relating to the work shown on the display unit together with the above obtained presentation information.

As another preferred feature, the display-control unit controls the display unit not to show thereon presentation information other than the presentation information relating to the work obtained by the information obtaining unit.

As yet another preferred feature, the work support system further comprises an image data storing unit storing image data relating to the work, and the display control unit controls the display unit to show thereon the presentation information together with the image data obtained from the image data storing unit.

As a further preferred feature, the work support information includes information about a position at which the presentation information is to be shown in the image data, and the display control unit controls the display unit to show thereon the presentation information at the position in the image data.

As a still further preferred feature, the work support information includes information about a display form in which the presentation information is to be shown, and the display control unit controls the display unit to show thereon the presentation information in the display form.

As another feature, the work support system further comprises a display form changing unit which is capable of changing the display form of the presentation information.

As a generic feature, there is provided a work support method in which presentation information relating to work to be carried out is displayed on a display unit for supporting a worker, the method comprising the steps of: (a) storing the presentation information, in association with work identification information identifying the work, as work support information; (b) inputting the work identification information relating to the work whose presentation information is expected to be shown; (c) obtaining the presentation information relating to the work identification information, input in the step (b), from the presentation information stored in the step (a); and (d) controlling the display unit to show thereon the presentation information obtained in the step (c).

As another generic feature, there is provided a computer-readable recording medium in which is recorded a work support program for instructing a computer to show presentation information for supporting a worker at work on a display unit, wherein the program instructs a computer to carry out the steps of: (a) storing the presentation information, in association with work identification information identifying the work, as work support information; (b) inputting the work identification information relating to the work whose presentation information is expected to be shown; (c) obtaining the presentation information relating to the work identification information, input in the step (b), from the presentation information stored in the step (a); and (d) controlling the display unit to show thereon the presentation information obtained in the step (c).

As yet another generic feature, there is provided a work support information creating system which creates work support information for supporting a worker at work, the system comprising: an image data storing unit storing image data relating to the work; a presentation information inputting unit through which presentation information to be shown to the worker is input; a work identification information inputting unit through which work identification information identifying the work is input; an information creating unit which creates the work support information by associating the image data stored in the image data storing unit, presentation information input through the presentation information inputting unit, and work identification information input through the work identification information inputting unit.

As a preferred feature, the information creating unit makes the work support information include information relating to a position at which the presentation information is to be shown in the image data.

As further generic feature, there is provided a work support information creating method for creating work support information which supports a worker who carries out work, the method comprising the steps of: (a) storing image data relating to the work; (b) inputting presentation information which is to be presented to the worker; (c) inputting work identification information which identifies the work; and (d) creating the work support information by associating the image data stored in the step (a), presentation information input in the step (b), and work identification information input in the step (c).

As a preferred feature, in the step (d) the work support information has information about a display position of the presentation information in the image data.

As a still further generic feature, there is provided a computer-readable recording medium in which is recorded a work support information creating program for instructing a computer to create a work support information to be shown to a worker for supporting the worker at work, wherein the program instructs a computer to carry out the steps of: (a) inputting presentation information which is to be presented to the worker; (b) inputting work identification information which identifies the work; and (c) creating the work support information by associating the image data relating to the work, presentation information input in the step (a), and work identification information input in the step (b).

As a preferred feature, at the time the work support information creating program instructs a computer to execute the step (c), the work support information has information about a display position of the presentation information in the image data.

The present invention realizes at least one of the following effects or advantages.

(1) It is possible for a worker to obtain only necessary information for the current work, so that user convenience is improved and the work efficiency of the worker is improved.

(2) It is possible to reduce load on a creator of work support information at the time of creating the work support information.

Other objects and further features of the present invention will be apparent from the following detailed description when read in conjunction with the accompanying drawings.

### BRIEF DESCRIPTION OF THE DRAWINGS

FIG. 1 is a diagram schematically showing a construction of a work support system according to one preferred embodiment of the present invention:

FIG. 2 is a diagram schematically showing a construction of a work support information creating system according to one preferred embodiment of the present invention;

FIG. 3 is a view of a data construction example of a note (work support information) created by a work support information creating system of the present embodiment;

FIG. 4 is a view showing an example of a work support information setting screen image shown on a display of the work support information creating system;

FIG. 5 is a view showing a work scene setting screen image shown on a display of the work support system of the present embodiment;

FIG. 6 is a view showing an example screen image in which comments in the work support system are shown;

FIG. 7 is a view showing an example screen image in which comments in the work support system are shown;

FIG. 8 is a view showing a data construction example of a note (work support information) used in a modified example of a work support information creating system of the present embodiment;

FIG. 9 is a view showing an example of a definition file set in the work support information creating system of the present embodiment;

FIG. 10 is a view showing a screen image in which image data in the work support system is shown together with comments relating to assembly;

FIG. 11 is a view showing a screen image in which image data in the work support system is shown together with comments relating to disassembly; and

FIG. 12 is a view showing an example of work instruction data created by a previous work support information creating method.

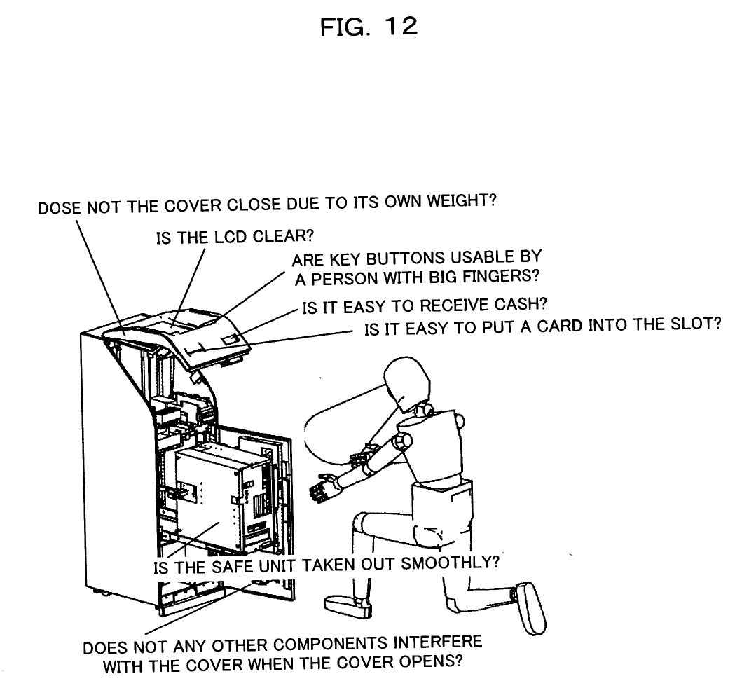

### DESCRIPTION OF THE PREFERRED EMBODIMENT(S)

One preferred embodiment of the present invention will now be described with reference to the relevant accompanying drawings.

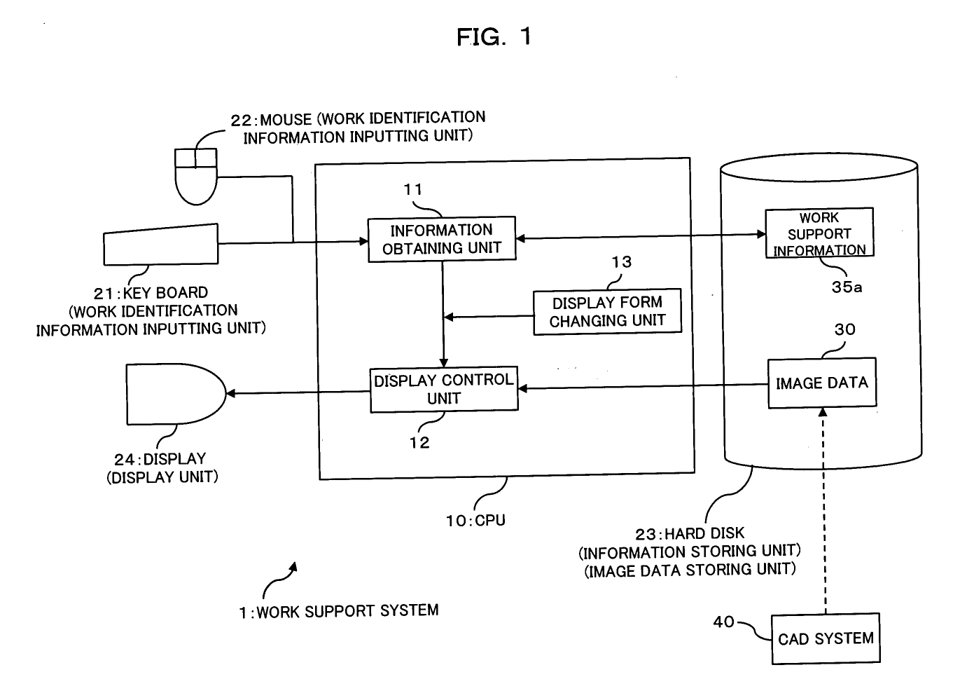

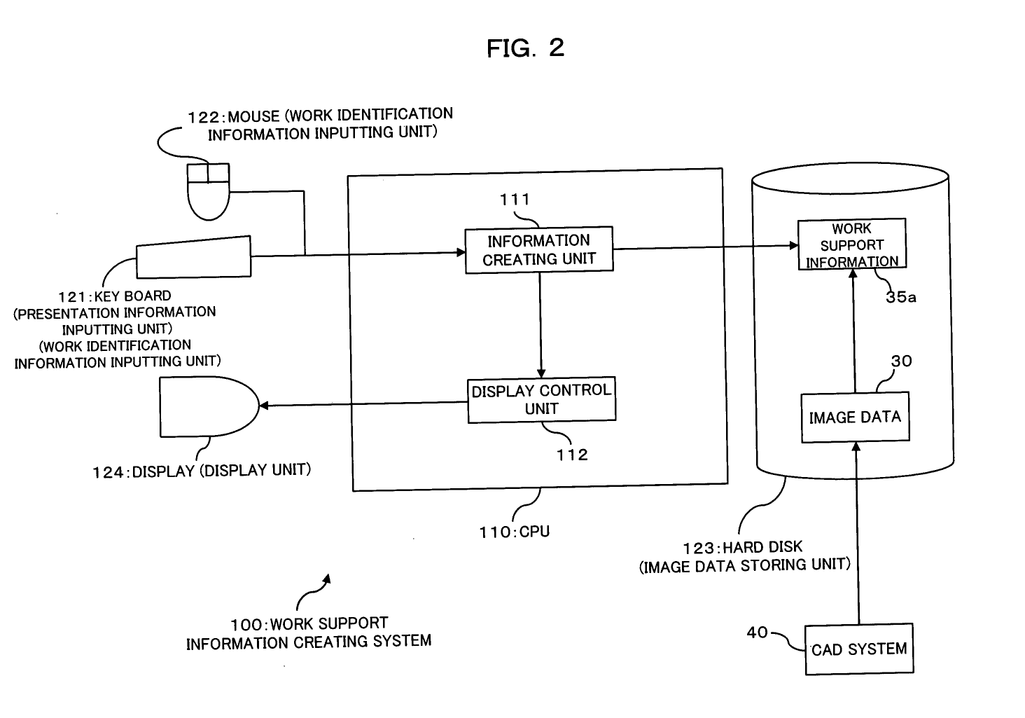

FIG. 1 is a diagram schematically showing a construction of a work support system according to one preferred embodiment of the present invention; FIG. 2 is diagram schematically showing a construction of a work support information creating system according to one preferred embodiment of the present invention.

The work support system 1 supports a worker at work using work support information for supporting the work. For example, a work manual (work support information) image in which an object of work [in the present embodiment, ATM (Automated Teller Machine)] and a human model are shown together with superimposed comments thereon are shown on a display 24 (see FIG. 1), whereby the work of the worker is supported.

(A) Work Support Information Creating System

First of all, a description will be made hereinbelow of a work support information creating system 100 according to one preferred embodiment of the present invention. The work support information creating system 100, which creates work support information, is constructed as a computer system including a keyboard 121, a mouse 122, a display 124, a CPU (information creating unit 111, display control unit 112), and a hard disk (image data storing unit) 123.

A description will be made hereinbelow of a work manual which is referred to by a worker at work, as an example of work support information.

The keyboard (presentation information inputting unit; work identification information inputting unit) 121 and the mouse (presentation information inputting unit, work identification information inputting unit) 122 are used by a person (hereinafter will be called the “operator”) who registers work support information in inputting various character letters and in selecting options. That is, the operator uses the keyboard 121 and the mouse 122 in inputting numerical and alphabetical characters and in selecting options.

In the present embodiment, the operator uses the keyboard 121 and the mouse 122 in inputting comments (presentation information) to be shown to a worker and work identification information (work scene) identifying the work.

The display 124 shows various types of information thereon, and is controlled by a display control unit 112 (will be described later).

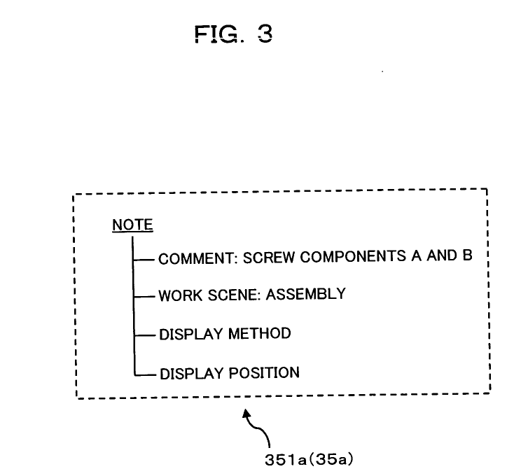

The hard disk 123 stores various types of data and programs. It stores not only an OS (Operating System) and various programs which make the present work support information creating system 100 function, but also image data 30 relating to an object of work and work support information 35a (Note 351a; see FIG. 3).

The image data 30 visibly shows the appearance and construction of the object of work in form of still pictures, motion pictures, schematic diagrams, and drawings. The image data 30 is created, for example, by a CAD (Computer Aided Design) and an image crating program. In the present embodiment, a description will be made on drawing data in which image data 30 is created by a CAD system 40.

Here, the CAD system 40, which creates the image data 30, can be a two-dimensional CAD or a three-dimensional CAD. Further, the computer system which serves as the work support information creating system 100 can function as a CAD system 40 by executing a program. Furthermore, image data can be obtained in some manners from an external CAD system 40 which is not included in the work support information creating system 100.

Further, if the image data 30 shows a construction of a structure which is formed by a combination of multiple components, the image data 30 has information about those components (for example, information for identifying components, and reference positions).

FIG. 3 is a view of a data construction example of a note 351a (work support information 35a) created by the work support information creating system 100 of the present embodiment. As shown in FIG. 2, the note 351a is constructed by a comment, a work scene, a display method, and a display position in association with one another, and is associated with image data 30. The work support information 35a includes multiple notes 351a.

Here, the work scene (work identification information) is information identifying work. For example, it includes information for identifying work contents and work processes such as assembly, disassembly, user inspection, maintenance inspection. In addition, comments (presentation information) are information presented together with image data to a worker. The comments correspond to work scenes are information in form of character letters indicating useful information and precautions for a worker.

The display method is information for identifying a display form in which the comments are shown on a display 124 (will be described later), and the format (font types font sizes, and the presence or absence of character decoration) of the character letters is registered.

In the present embodiment, the display form in which comments are displayed on the display 24 of the work support system 1 is registered as a display method. For example, as to a certain image data, when other comments are registered for another work scene, setting such that the other comments are not displayed, and such that those comments are displayed in different display form (format, etc.) can be registered as a display method.

A display position is information identifying the position at which comments are to be displayed. Information (file name, path, address of storage place and soon) identifying the image data, and display position at which comments are to be displayed on the image data, coordinate values, and information for identifying components are registered.

The CPU (Central Processing Unit) 110 realizes various functions of the work support information creating system 100 by executing/operating an OS (Operating System) and programs stored in the hard disk 123 and a RAM and a ROM (not illustrated). The CPU 110 executes a work support information creating program, thereby functioning as an information creating unit 111 and display control unit 112 (will be detailed later).

The programs (work support information creating program) for realizing the functions of the information creating unit 111 and the display control unit 112 are recorded in computer-readable recording media such as flexible discs, CDs (CD-ROMs, CD-Rs, CD-RWs, and so on), DVDs (DVD-ROMs, DVD-RAMs, DVD-Rs, DVD+Rs, DVD-RWs, DVD+RWs and so on), magnetic discs, optical discs, and magneto-optical discs. The computer reads the programs from such recording media to transfer the programs to an internal or external storage device, to store the programs therein. Alternatively, the programs can be recorded in storage devices (recording media) such as magnetic discs, optical discs, and magneto-optical discs, to be transferred to the computer over a communication network.

When the functions of information creating unit 111 and the display control unit 112 are realized, programs stored in an internal storage device (a RAM or ROM unillustrated in the present embodiment) are executed by a microprocessor (CPU 110 in the present embodiment) of the computer. Here, programs stored in a recording medium can be read out to be executed by the computer.

Here, the “computer” is defined as a concept including hardware and an OS (Operating System), or hardware operating under control of an OS. Further, in cases where hardware is capable of operating by itself without the necessity of an OS, the hardware is equivalent to the “computer.” The hardware includes at least a micro processor such as a CPU and a means for reading computer programs from recording media. In the present embodiment, the work support information creating system 100 serves as the computer.

Moreover, as recording media used in the embodiments of the present embodiment, not only the above-mentioned flexible discs, CDs, DVDs, magnetic discs, optical discs, and magneto-optical discs, but also various types of other computer-readable media, such as IC cards, ROM cartridges, magnetic tapes, punch cards, internal storage devices (memories such as RAMs and ROMs), external storage devices, and printed matter with any codes such as barcodes printed thereon, are also applicable.

The display control unit 112 controls display 124 to show various types of information thereon.

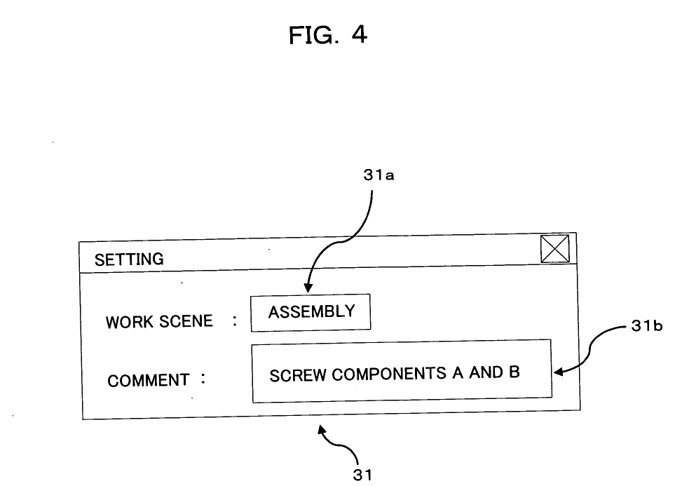

FIG. 4 shows an example of a work support information setting screen image 31 shown on the display 124 of the work support information creating system 100 of the preset embodiment. The work support information setting screen image 31 of FIG. 4, which is provided in association with an image data, is for inputting comments and a work scene to be associated with an image data therethrough. The work support information setting screen image 31 has a work scene inputting field 31a into which a work scene is to be input, and a comment input field 31b into which comments are to be input.

An operator uses the keyboard 121 and the mouse 122 to input information to be registered into the work scene inputting field 31a and the comment input field 31b in the work support information setting screen image 31. The information input through the work support information setting screen image 31 is stored in a RAM or the like, and is then transferred to the information creating unit 111.

The information creating unit 111 creates note 351a (work support information 35a) by associating the work scene and the comments input through the work support information setting screen image 31 with image data. That is, the information creating unit 111 associates the image data stored in the hard disk 123 and comments input through the keyboard 121 and the work scene input through the keyboard 121 to create note 351a. The note 351a created by the information creating unit 111 is stored in the hard disk 123.

(B) Work Support System

Next, a description will be made hereinbelow of the work support system 1 according to one preferred embodiment of the present invention. The work support system 1 shows comments (presentation information) together with image data to support a worker at work. As shown in FIG. 1, the work support system 1 includes a keyboard (work identification information inputting unit) 21, a mouse (work identification information inputting unit) 22, a display (display unit) 24, a hard disk 23, and a CPU (information obtaining unit 11, display control unit 12, and display form changing unit 13) 10.

Like reference numbers and characters designate similar parts or elements throughout several views, so their detailed description is omitted here.

The display 24 shows various types of information, and is controlled by a display control unit 12 (will be described later).

The keyboard (work identification information inputting unit) 21 and the mouse (work identification information inputting unit) 22 are used by a worker in inputting various character letters or in selecting options. That is, the worker uses the keyboard 21 and the mouse 22 in inputting numerical and alphabetical characters and in selecting options.

In the present embodiment, the worker uses the keyboard 21 and the mouse 22 in inputting (selecting) a work scene whose image data and comments are expected to be shown.

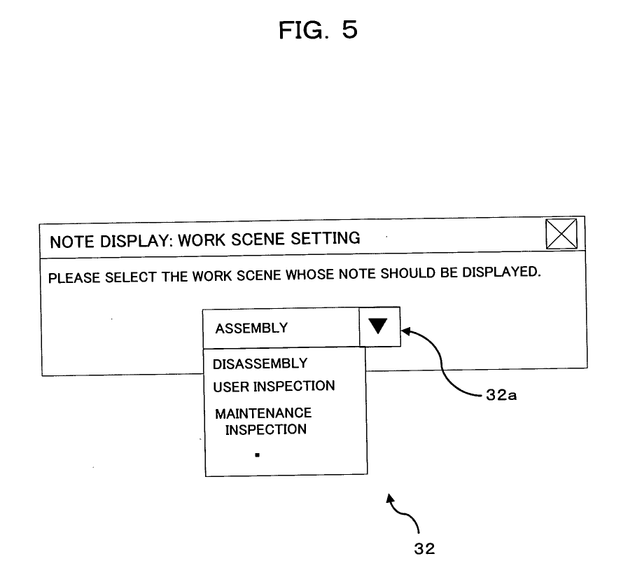

FIG. 5 is a view showing a work scene setting screen image 32 shown on the display 24 of the work support system 1 of the present embodiment. The work scene setting screen image 32 of FIG. 5 is provided in association with image data, and is for selecting (setting) a work scene whose comments are expected to be shown in the image data. The work scene setting screen image 32 includes a work scene selecting field 32a for selecting a work scene.

In FIG. 5, the work scene selecting field 32a is provided as a pull-down menu (drop-down menu) which shows more than one selective work scenes. From the menu, an arbitrary work scene is selected using the key board 21 and the mouse 22. The work scene selected on this work scene setting screen image 32 is notified to a CPU (information obtaining unit 11) 10 (will be described later).

The hard disk 23 stores various types of data and programs therein. It stores an OS and various programs which make the work support system 1 function, and also stores image data 30 relating to an object of work and a note 351a (work support information 35a) created by the work support information creating system 100. The hard disk 23 serves as an information storage unit which stores comments and work scenes as associated work support information, and also serves as an image data storage unit which stores image data relating to objects of works.

Like the CPU 110 of the work support information creating system 100, the CPU (Central Processing Unit) 10 realizes various functions of the work support system 1 by executing/operating an OS (Operating System) and programs stored in the hard disk 23 and a RAM and a ROM (not illustrated). The CPU 10 executes a work support program, thereby functioning as an information obtaining unit 11 and a display form changing unit 13, and a display control unit 12 (will be detailed later).

Here, the programs (work support program) for realizing the information obtaining unit 11, the display form changing unit 13, and the display control unit 12 are recorded in computer-readable recording media such as flexible discs, CDs, DVDs, magnetic discs, optical discs, and magneto-optical discs. The computer reads the programs from such recording media to transfer the programs to an internal or external storage device, to store the programs therein. Alternatively, the programs can be recorded in storage devices (recording media) such as magnetic discs, optical discs, and magneto-optical discs, to be transferred to the computer over a communication network.

When the functions of the information obtaining unit 11, display form changing unit 13, and display control unit 12 are realized, programs stored in an internal storage device (a RAM or ROM unillustrated in the present embodiment) are executed by a microprocessor (CPU 110 in the present embodiment) of the computer. Here, programs stored in a recording medium can be read out to be executed by the computer.

The information obtaining unit 11 obtains work support information (comments, etc.) from the hard disk 23, based on the work scene input through the work scene setting screen image 32 on the display 24 with the keyboard 21 and the mouse 22.

In addition, the information obtained by the information obtaining unit 11 is transferred to the display control unit 12.

The display form changing unit 13 changes the display form of comments shown on the display 24. It changes the display form of work support information, such as the format (font type, font size, the presence or absence of character decoration) of the comments and the display form (display/non-display) of the comments relating to other work scenes.

The display form changed by the display form changing unit 13 is notified to a display control unit 12 (will be detailed later), and the display control unit 12 controls the display 24 to show the comment in the changed display form.

Further, the contents of the display method changed by the display form changing unit 13 are temporarily stored in an unillustrated memory or the like, and are replaced by the information of the display form of note 351a stored in the hard disk 23.

The display control unit 12 controls the display 24 to show various types of information thereon. The display control unit 12 controls the display 24 to show thereon the comment obtained by the information obtaining unit 11 together with its associated image data. Further, when controlling the display 24 to show the comment thereon, the display control unit 12 controls the display 24 to show the comment according to the display method registered in its note 351a.

More specifically, based on the display method of the note 351a, the display control unit 12 controls the display 24 to show the comment in a set format. As to image data, when other comments are registered in other work scene, the display control unit 12 controls the display 24 not to display such other comment, and to show only the comment associated with the selected work scene, overlaying the comment on the image data. Further, the display control unit 12 controls the display 24 to show the comments corresponding to the selected work scene in different display form (format, etc.) from other comments, overlaying the comment on the image data.

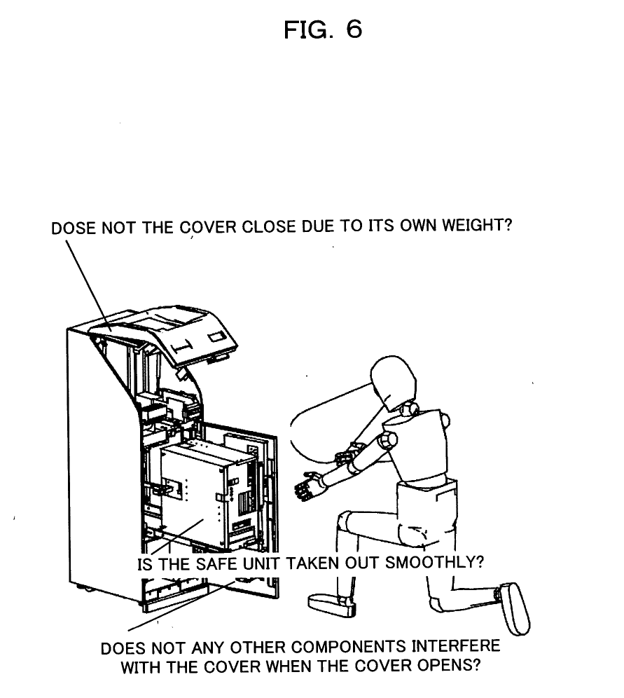

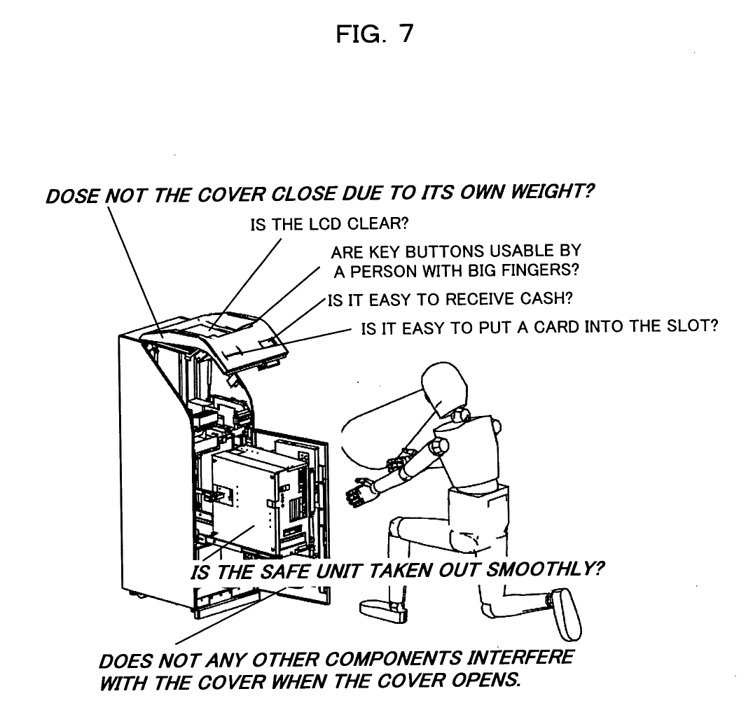

FIG. 6 and FIG. 7 are views each showing an example screen image in which comments in the work support system 1 are shown. FIG. 6 is a view in which comments relating to other work scenes are not shown. FIG. 7 is a view in which selected comments are displayed in a display form different from that of other comments relating to other work scenes.

Here, in the example of FIG. 6, comments relating to the work scene of “maintenance inspection” are displayed together with image data. In the example of FIG. 7, the comments relating to the work scene of “maintenance inspection” is shown with a bold font in italics, and further, the messages are shown with bigger font size letters in comparison with the comments relating to other work scenes.

In the work support system 1 of the present embodiment, when a worker makes the image data of the work shown on the display 24, the worker selects a desired work scene by using the work scene selecting field 32a in the work scene setting screen image 32 (see FIG. 5) shown on the display 24.

As a result, as shown in FIG. 6 and FIG. 7, on the display 24, only comments relating to the selected work scene are shown together with the image data on the display 24, or comments relating to the selected work scene are shown in a display form different from other comments relating to other work scene. The worker refers to the image data and the comments shown on the display 24 at work.

In this manner, according to the work support system 1 of the present embodiment, it is possible for a worker to easily obtain information necessary at the current work scene, so that the work efficiency of the worker is improved.

In addition, in the work support information creating system 100, at the time work support information is created, the display 24 shows only comments relating to a specified work scene as shown in FIG. 6 and FIG. 7. Thus, it is visibly clear which notes (comments) are display candidates, so that load on a creator (operator) who creates work support information is reduced.

Further, notes a user wants to display are switched according to work scenes.

Further, the work scene setting image 32 as shown in FIG. 5 is displayed while work support information is being created, whereby comments displayed on the display 124 can be selectively displayed. As a result, it is possible narrow down the note candidates the operator (creator) makes the display 124 show thereon, so that load at the time work support information is created is reduced.

(C) Modified Example

Further, the present invention should by no means be limited to the above-illustrated embodiment, but various changes or modifications may be suggested without departing from the gist of the invention.

For example, in the above embodiment, as shown in FIG. 6 and FIG. 7, comments relating to different work scenes are shown in the same screen image at different positions. The present invention should by no means be limited to this, comments relating to different work scenes can be selectively shown in the same screen image at the same positions.

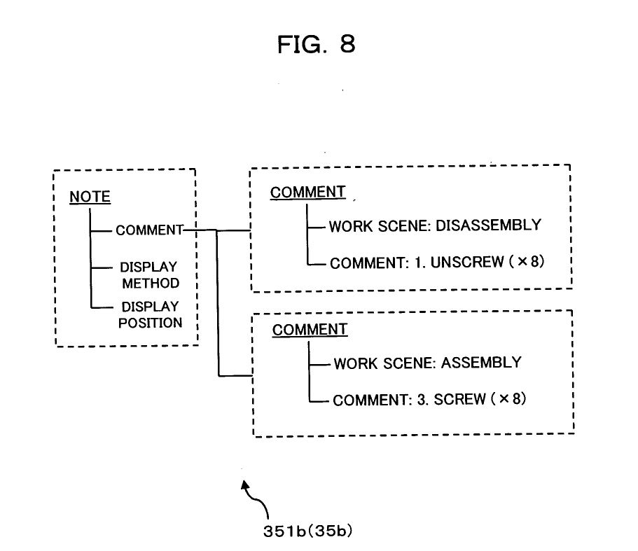

FIG. 8 is a view showing a data construction example of a note 351b (work support information 35b) used in a modified example of a work support system 1 and a work support information creating system 100. As show in FIG. 3, the note 351b is constructed by associating ID, comment, work scene, display method, and display position with one another, and is associated with image data 30. Work support information 35b has more than one note 351b.

Note that already described items are the same or approximately the same, and thus detailed description of the items are omitted here.

The note 351b is associated with one item of image data 30, and has different comments corresponding to different work scenes. These multiple comments and work scenes are associated with the same display position of the image data.

For example, in the example of FIG. 8, two work scenes of “disassembly” and “assembly” are set as work scenes. Further, the comment, “1. unscrew (×8)”, is associated with the work scene “disassembly”: the comment, “3. screw (×8)”, is associated with the work scene “assembly”.

Further, in the work support system 1, these comments are selectively displayed in the image data at the same display position according to the display position in the note. When a certain work scene is selected through the keyboard 21 and the mouse 22, the comment corresponding to the selected work scene is shown on the display 24 at a position which is set as a display position of the note.

As shown in FIG. 8, as a method for registering a comment, a work scene can be individually associated with a comment. Alternatively, a definition file in which a comment for each work scene is defined is set, and the work support system 1 can read in such a definition file.

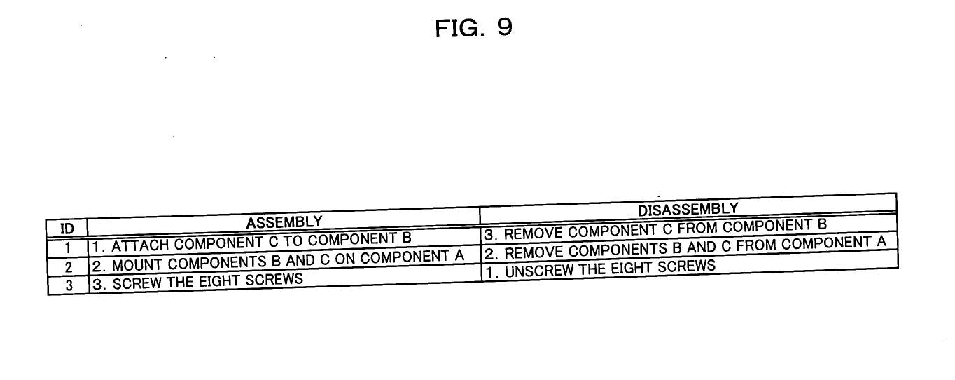

FIG. 9 shows an example of a definition file set in the work support information creating system 100. In the example of FIG. 9, three comments (ID=1, 2, and 3) are set for each of the two work scenes, assembly and disassembly.

“Assembly” and “disassembly” in a manufacturing process can be reversibly expressed. For example, by attaching component C to component B, an assembly process can be expressed, and by detaching component C from component B, a disassembly process can be expressed.

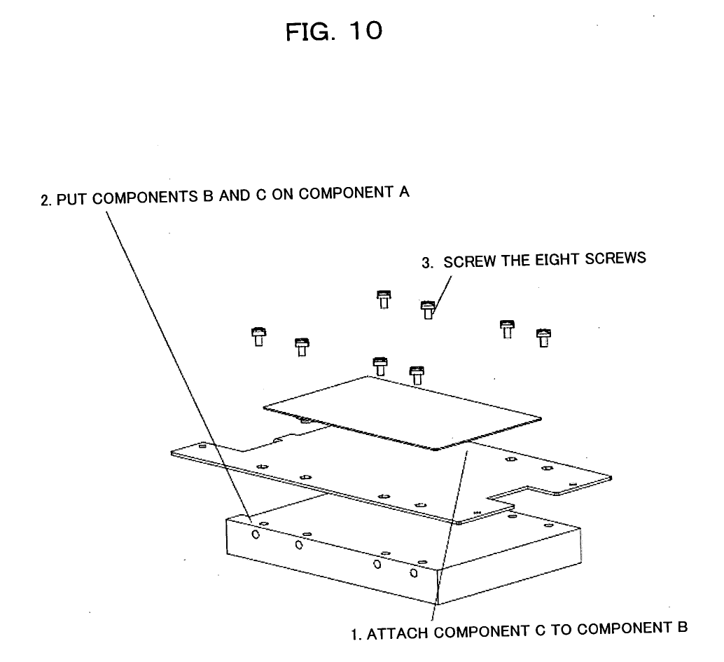

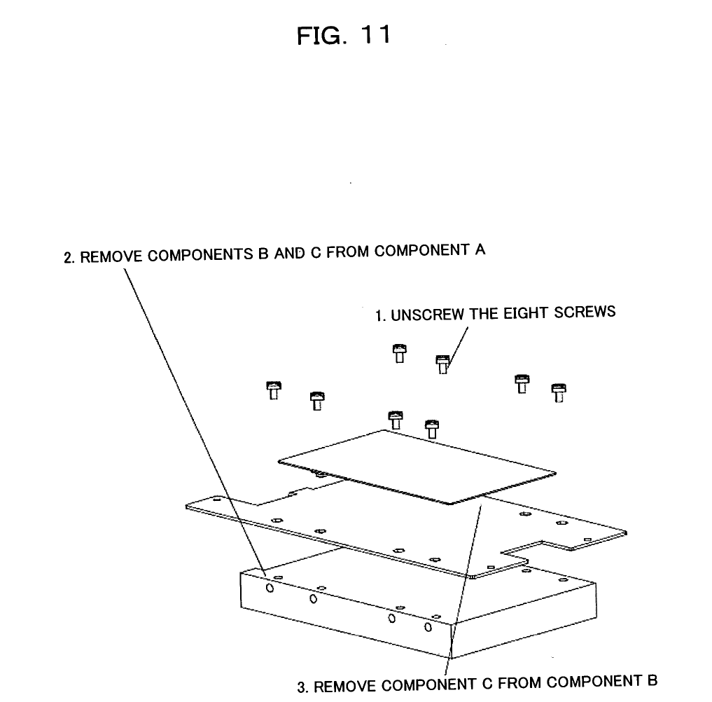

FIG. 10 is a view showing a screen image in which image data in the work support system 1 is shown together with comments relating to assembly; FIG. 11 is a view showing a screen image in which image data in the work support system 1 is shown together with comments relating to disassembly.

Under the condition, as shown in FIG. 10, where comments relating to the work scene “assembly” are shown, if “disassembly” is selected with the keyboard 21 or the mouse 22, comments relating to the work scene “disassembly” are shown at the same positions as the comments for “assembly” on the display 24.

As a result, in the work support information creating system 100, an operator only needs to set/insert the contents of the comment of the note, to display the notes on the display 24 without changing the display positions of the notes, so that load on the operator in resetting the display position of the notes is eliminated.

In addition, when an image of work data is identical but with different comments, and when work data (work instruction) can be created only by reversing the direction in which motion picture image data is replayed, it is possible to easily create support information for multiple works only by changing comments to be shown.

Further, since comments can be changed maintaining the display position of the notes, it is possible to eliminate the operator's work of inputting the display position.

Furthermore, in each work scene, comments to be shown can be selected. In addition, by selecting only the comments to be shown, it is possible to make the display positions of the comments in each work scene the same.

In the above embodiment, image data is created by the CAD system 40, but the present invention should by no means be limited to this, and the image data can be created by a program (an image creating program or a program which creates a schematic diagram) different from CAD.

Further, in the above embodiment, comments are overlaid on the image data, thereby supporting the worker. The present invention should by no means be limited to this, and links and icons can be shown on the image data to execute any types of useful data for the worker, such as sound files or any other image data.

Moreover, in the above embodiment, work support information and image data are stored in the same hard disk 123 and 23. The present invention should by no means be limited to this, and the work support information and image data can be stored in different storage areas. Further, the places in which such work support information and image data is stored should not be limited to a hard disk 123 and 23 connected to a computer, which serves as the work support information creating system 100, and such information and image data can be stored in a storage device which is communicably connected to a computer which serves as the work support information creating system 100 through a LAN or the like.

What is claimed is:

1. A work support system which shows a worker presentation information for supporting the worker at work, said system comprising:
a display unit which shows the presentation information thereon;
an information storing unit which stores therein the presentation information and work identification information identifying the work as associated work support information;
a work identification information inputting unit through which the work identification information relating to work whose presentation information is expected to be shown is input;
an information obtaining unit which obtains the presentation information relating to the work identification information, input through said work identification information inputting unit, from said information storing unit; and
a display control unit which controls said display unit to show thereon the presentation information obtained by said information obtaining unit.

2. A work support system as set forth in claim 1, wherein said display control unit controls said display unit to show thereon the presentation information obtained by said information obtaining unit in a display form different from that of other presentation information relating to the work shown on said display unit together with the above obtained presentation information.

3. A work support system as set forth in claim 1, wherein said display control unit controls said display unit not to show thereon presentation information other than the presentation information relating to the work obtained by said information obtaining unit.

4. A work support system as set forth in claim 1, further comprising an image data storing unit storing image data relating to the work,
said display control unit controlling said display unit to show thereon the presentation information together with the image data obtained from said image data storing unit.

5. A work support system as set forth in claim 2, further comprising an image data storing unit storing image data relating to the work,
said display control unit controlling said display unit to show thereon the presentation information together with the image data obtained from said image data storing unit.

6. A work support system as set forth in claim 3, further comprising an image data storing unit storing image data relating to the work,
said display control unit controlling said display unit to show thereon the presentation information together with the image data obtained from said image data storing unit.

7. A work support system as set forth in claim 4,
wherein the work support information includes information about a position at which the presentation information is to be shown in the image data, and
wherein said display control unit controls said display unit to show thereon the presentation information at the position in the image data.

8. A work support system as set forth in claim 5,
wherein the work support information includes information about a position at which the presentation information is to be shown in the image data, and
wherein said display control unit controls said display unit to show thereon the presentation information at the position in the image data.

9. A work support system as set forth in claim 6,
wherein the work support information includes information about a position at which the presentation information is to be shown in the image data, and
wherein said display control unit controls said display unit to show thereon the presentation information at the position in the image data.

10. A work support system as set forth in claim 1,
wherein the work support information includes information about a display form in which the presentation information is to be shown, and
wherein said display control unit controls said display unit to show thereon the presentation information in the display form.

11. A work support system as set forth in claim 2,
wherein the work support information includes information about a display form in which the presentation information is to be shown, and
wherein said display control unit controls said display unit to show thereon the presentation information in the display form.

12. A work support system as set forth in claim 10, further comprising a display form changing unit which is capable of changing the display form of the presentation information.

13. A work support method in which presentation information relating to work to be carried out is displayed on a display unit for supporting a worker, said method comprising the steps of:
(a) storing the presentation information, in association with work identification information identifying the work, as work support information;
(b) inputting the work identification information relating to the work whose presentation information is expected to be shown;
(c) obtaining the presentation information relating to the work identification information, input in the step (b), from the presentation information stored in the step (a); and
(d) controlling the display unit to show thereon the presentation information obtained in the step (c).

14. A computer-readable recording medium in which is recorded a work support program for instructing a computer to show presentation information for supporting a worker at work on a display unit, wherein said program instructs a computer to carry out the steps of:
a) storing the presentation information, in association with work identification information identifying the work, as work support information;
(b) inputting the work identification information relating to the work whose presentation information is expected to be shown;
(c) obtaining the presentation information relating to the work identification information, input in the step (b), from the presentation information stored in the step (a); and
(d) controlling the display unit to show thereon the presentation information obtained in the step (c).

15. A work support information creating system which creates work support information for supporting a worker at work, said system comprising:
an image data storing unit storing image data relating to the work;
a presentation information inputting unit through which presentation information to be shown to the worker is input;
a work identification information inputting unit through which work identification information identifying the work is input;
an information creating unit which creates the work support information by associating the image data stored in said image data storing unit, presentation information input through said presentation information inputting unit, and work identification information input through said work identification information inputting unit.

16. A work support information creating system as set forth in claim 15, wherein said information creating unit makes the work support information include information relating to a position at which the presentation information is to be shown in the image data.

17. A work support information creating method for creating work support information which supports a worker who carries out work, said method comprising the steps of:
(a) storing image data relating to the work;
(b) inputting presentation information which is to be presented to the worker;
(c) inputting work identification information which identifies the work; and
(d) creating the work support information by associating the image data stored in the step (a), presentation information input in the step (b), and work identification information input in the step (c).

18. A work support information creating method as set forth in claim 17, wherein in the step (d) the work support information has information about a display position of the presentation information in the image data.

19. A computer-readable recording medium in which is recorded a work support information creating program for instructing a computer to create a work support information to be shown to a worker for supporting the worker at work, wherein said program instructs a computer to carry out the steps of:
(a) inputting presentation information which is to be presented to the worker;
(b) inputting work identification information which identifies the work; and
(c) creating the work support information by associating the image data relating to the work, presentation information input in the step (a), and work identification information input in the step (b).

20. A computer-readable recording medium as set forth in claim 19, wherein at the time the work support information creating program instructs a computer to execute the step (c), the work support information has information about a display position of the presentation information in the image data.
